(19) United States
(12) Patent Application Publication
(10) Pub. No.: US 2012/0168575 A1
(43) Pub. Date: Jul. 5, 2012

(54) Wrist Pad

(75) Inventor: Jack ATZMON, Englewood, NJ (US)

(73) Assignee: Ergowerx International LLC, Englewood, NJ (US)

(21) Appl. No.: 13/340,325

(22) Filed: Dec. 29, 2011

Related U.S. Application Data
(60) Provisional application No. 61/429,028, filed on Dec. 31, 2010.

(51) Int. Cl. B68G 5/00; A47G 29/08

(52) U.S. Cl. 248/118; 248/346.01

(57) ABSTRACT

A wristpad that is adapted to slide on a first surface while supporting a user's wrist on a second surface. The wristpad includes a material that molds itself to the user's wrist.

### RELATED APPLICATIONS

This application claims priority from U.S. Provisional Patent Application Ser. No. 61/429,028 which was filed on Dec. 31, 2010.

### BACKGROUND OF THE INVENTION

1. Field of the Invention

The present invention relates to wristpads, and more particularly to an ergonomic wristpad for use with a computer mouse, a computer keyboard, and the like.

2. Description of the Related Art

A known wristpad for computer mice and keyboards comprises a fixed, raised pad. This stationary pad fails to provide the necessary support as a user's hand and wrist move.

### SUMMARY OF THE INVENTION

While the foregoing described prior art device has provided improvement over no support, there remains a continuing need in the art for work station environments and apparatuses that provide further attention to the physical needs of the user.

An object of the present invention is to provide a wrist support that moves with the user to provide continuous support.

One embodiment of the invention comprises a pad. Preferably, the pad is a gel pad. The gel pad is preferably covered with a cover. The cover has two different surfaces. A first surface of the cover is configured to have a low coefficient of friction to slide on a surface. The second surface of the cover is configured to have a coefficient of friction that is higher than the first surface so a user's wrist does not slide off the wrist support and the wrist support slides as the user's hand traverse the surface. In an alternative embodiment, upper and lower surfaces of the pad itself provide the required coefficients of friction without a cover.

In a preferred embodiment, the gel pad is stitched into the cover. In an alternative embodiment, the gel pad is removeably inserted into the cover so that the cover can be removed and cleaned. A zipper, buttons, Velcro™, or the like, is provided to ease removal of the gel pad from the cover.

In one embodiment, the gel, or other material, can be heated or cooled. For example, the pad can be chilled in a freezer or warmed in a microwave oven.

Preferably, the cover has two distinct materials.

In one embodiment, the user surface of the cover has bumps or the like for friction.

In one embodiment, the support comprises a tray in which a gel pad is seated. The tray preferably has slides on a bottom surface to ease the traversal of a surface. In one embodiment, the slides are formed integrally with the tray.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

Further features and advantages of the invention are specified below accompanied by descriptions of exemplary embodiments and with reference to the figures in the drawing. In said drawing:

FIG. 1 perspective view of the wristpad;

FIG. 2 is a side view of the wristpad;

FIG. 3 is perspective view of a wristpad in a tray; and

FIG. 4 is cross section of the wristpad in a tray of FIG. 3.

### DETAILED DESCRIPTION OF THE PRESENTLY PREFERRED EMBODIMENTS

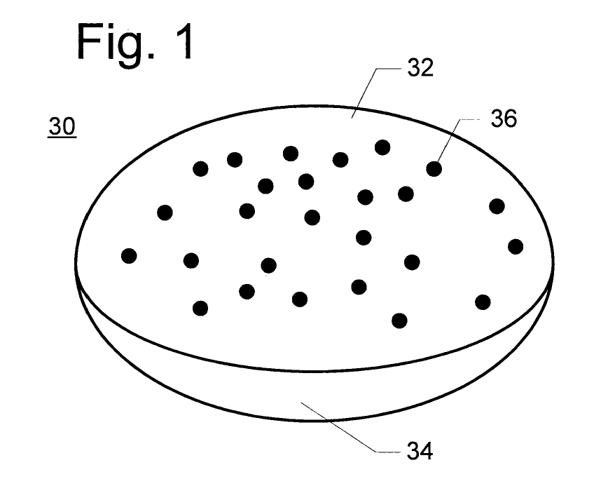

FIG. 1 is a wrist support according to a first embodiment of the invention. As shown, a support 30 includes a first surface 34. The first surface 34 is a bottom surface adapted to slide on a support surface. As such, the first surface 34 preferably has a low coefficient of friction. A second surface 32 of support 30 preferably has a higher coefficient of friction than surface 34. In one embodiment, the higher coefficient of friction is due to friction bumps 36. Friction bumps 36 can be rubber bumps, or bumps formed integrally with surface 32.

In one embodiment, the first and second surfaces 32, 34 retain a gel. Alternatively, the first and second surfaces 32, 34 retain sand, beads, rice, foam, or other moldable material. The moldable material preferably has thermodynamic properties such that it retains heat or cold. Thus, the support 30 can be cooled in a refrigerator or freezer warmed in a microwave.

In one embodiment, the support 30 comprises an insert and a cover for the insert. Preferably, the cover is removable for cleaning. The cover can be one material or a combination of materials. For example, both first and second surfaces 32, 34 can be satin. Alternatively, first surface 32 can be satin or another smooth material and second surface 34 can be cotton, terry cloth, or the like. In one embodiment, the first surface is Teflon.

In one embodiment, the first surface 34 is a flat smooth disk and the second surface is a malleable surface.

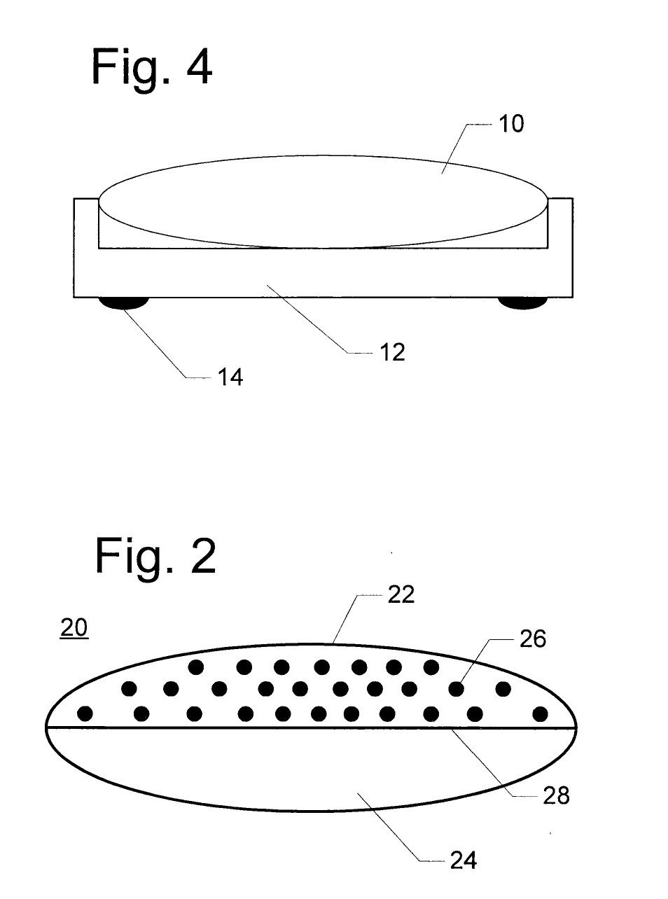

FIG. 2 is a side view of support 20. Support 20 comprises a gel insert and a cover. As shown, the cover has a first surface 24 that is a bottom surface adapted to slide on a support surface. As such, the first surface 24 preferably has a low coefficient of friction. A second surface 22 of support 20 preferably has a higher coefficient of friction than surface 24. In one embodiment, the higher coefficient of friction is due to friction bumps 26. The cover preferably has a seam 25. The gel insert is preferably removeable via the seam. The seam 25 can be sealed using hook and eye connectors (Velcro™), a zipper, buttons, or the like.

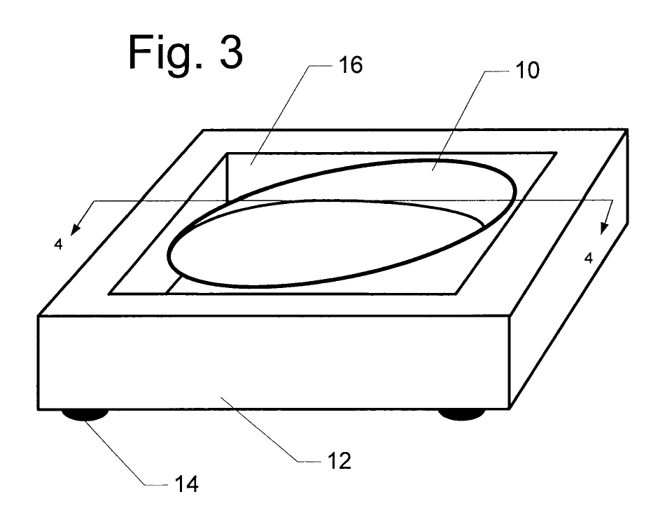

FIG. 3 is an alternative embodiment of the invention. In this embodiment, the a pad 10 is arranged in a tray 12. The pad 10 is preferably a pad configured in accordance with FIGS. 1 and 2 discussed above. However, any support pad can be used. The tray 12 includes a recess 16 in which pad 10 is arranged. Preferably, the pad 10 is removable from tray 12. The tray 12 is preferably plastic but can be a low friction material such as Teflon. In one embodiment, tray 12 has feet 14 configured to slide on a support surface. Feet 14 can be added to the tray 12 of formed integrally with the tray 12

FIG. 4 is a cross section of the embodiment of FIG. 3. As shown, the pad 10 is oval, however, the pad 10 can be any shape including round, square, rectangular, star-shaped, and the like. As shown, the tray 12 is square, however, the tray 12 can be any shape including round, oval, rectangular, star-shaped, and the like. The pad 10 and/or the tray 12 can also be a novelty shape such as a car, a truck, a martini glass, a telephone, or the like.

In one embodiment, the pad 10 can be removed from the tray 12 and used without the tray 12.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps that perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A wristpad comprising:
a moldable material;
a cover configured to cover the moldable material, the cover having a first surface with a low coefficient of friction configured to slide on a surface and a second surface with a opposite the first surface that mates with a user.

2. The wristpad of claim 1, wherein the moldable material is adapted to conform to a user's appendage rested on the first surface.

3. The wristpad of claim 1, wherein the moldable material is a configured to be at least one of warmed and cooled.

4. The wristpad of claim 1, wherein the cover further comprises friction elements arranged on the second surface.

5. The wristpad of claim 1, wherein the moldable material is a gel.

6. The wristpad of claim 1, wherein the moldable material is a plurality of beads.

7. A wristpad comprising:
a moldable material; and
a tray configured to retain the moldable material on a first side, the tray having a second surface opposite the first side with a low coefficient of friction configured to slide on a support surface.
